(19) United States
(12) Patent Application Publication
(10) Pub. No.: US 2022/0067612 A1
(43) Pub. Date: Mar. 3, 2022

(54) SYSTEM AND METHOD OF DELIVERING PACKAGE BY USING DRONE

(71) Applicants: Hyundai Motor Company, Seoul (KR); Kia Motors Corporation, Seoul (KR)

(72) Inventors: Sang Heon LEE, Seoul (KR); Jin Ho HWANG, Whasung-Si (KR); Dong Eun CHA, Whasung-Si (KR)

(73) Assignees: Hyundai Motor Company, Seoul (KR); Kia Motors Corporation, Seoul (KR)

(21) Appl. No.: 17/142,550

(22) Filed: Jan. 6, 2021

(30) Foreign Application Priority Data
Sep. 3, 2020 (KR) 10-2020-0112110

(51) Int. Cl. G06Q 10/06; G06Q 10/08; G06Q 20/08; B64C 39/02; G05D 1/12; G05D 1/10; G01G 19/08; G06T 7/60

(52) U.S. Cl. CPC G06Q 10/06315; G06Q 10/08355; G06Q 10/08345; G06Q 20/085; B64C 39/024; G06T 2207/10032; G05D 1/104; G01G 19/08; G06T 7/60; B64C 2201/128; G05D 1/12

(57) ABSTRACT

A system and a method of delivering a package by use of at least one drone, may include the at least one drone configured for picking up and delivering the package; and a server configured for receiving a request for delivering the package, selecting a drone to be used for delivery of the package among the at least one drone, making the selected drone pick up the package at a pick-up place, making a delivery plan from the pick-up place to a delivery destination, and making the selected drone deliver the package directly to the delivery destination or deliver the package to an intermediate destination before the delivery destination.

### CROSS REFERENCE TO RELATED APPLICATION

The present application claims priority to Korean Patent Application No. 10-2020-0112110, filed Sep. 3, 2020, the entire contents of which is incorporated herein for all purposes by this reference.

### BACKGROUND OF THE INVENTION

### Field of the Invention

The present invention relates to a system and a method of delivering a package by use of a drone, wherein a package requested to be delivered is picked up by use of a drone, and in combination with an existing package delivery system, the drone delivers the package to a final destination or an intermediate destination according to a situation, assisting the package delivery system and increasing the efficiency of the system.

### Description of Related Art

An existing package delivery system is a system in which when a customer makes a request for package delivery of the package, a delivery agent visits a delivery request place and takes the package to a distribution center, and the delivery agent reclassifies the package according to a destination in the distribution center and delivers the package accordingly.

In the present system, it is inconvenient for the delivery agent to visit the delivery request place of every customer manually. Furthermore, it takes an amount of time and decreases efficiency for the delivery agent to reclassify the package in the distribution center, and deliver the package to a warehouse near the destination or to the destination by loading the package in a distribution vehicle and visiting the destination manually.

Accordingly, it is necessary to develop a delivery system or method for increasing the efficiency of the existing package delivery system while using the existing package delivery system.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a system and a method of delivering a package by use of a drone, wherein a package requested to be delivered is picked up by use of a drone, and in association with an existing package delivery system, a server is configured to make the drone deliver the package to a final destination or an intermediate destination according to a situation, increasing the efficiency of the package delivery system.

According to various exemplary embodiments of the present invention, there is provided a system for delivering a package by use of at least one drone, the system including: the at least one drone configured for picking up and delivering the package; and a server configured for receiving a request for delivering the package, selecting a drone to be used for delivery of the package among the at least one drone, making the selected drone pick up the package at a pick-up place, making a delivery plan from the pick-up place to a delivery destination, and making the selected drone deliver the package directly to the delivery destination or deliver the package to an intermediate destination before the delivery destination.

When a designated user terminal makes the request for delivery of the package, the server is configured to select a drone positioned nearest to the pick-up place at which the package requested by a user to be delivered is positioned among the at least one drone, and guides the selected drone positioned nearest to the pick-up place, to the pick-up place.

The server may make the delivery plan on the basis of a location of the pick-up place, a location of the delivery destination, or a location of the intermediate destination and guides the selected drone according to the delivery plan, and the intermediate destination may include a distribution center or a distribution vehicle.

The drone may be provided with a pick-up sensor to recognize a pick-up point provided in the pick-up place, and when the package is positioned at the pick-up point, the server is configured to make the drone pick up the package.

The drone may be provided with a camera to collect image data of the package, and the server may use the image data collected by the camera of the drone to determine whether the package has a size that the drone is able to carry, and when the package has the size that the drone is able to carry, the server is configured to make the drone pick up the package at the pick-up place.

The drone may be provided with a weight sensor to collect weight data of the package, and the server may use the weight data collected by the weight sensor of the drone to determine whether the package has a weight that the drone is able to carry, and when the package has the weight that the drone is able to carry, the server is configured to make the drone pick up the package at the pick-up place.

The drone may be provided with a camera to collect image data of the package or a weight sensor to collect weight data of the package, and the server may use the image data or the weight data collected by the camera or the weight sensor of the drone to determine a delivery cost of the package.

The server may transmit the determined delivery cost to a designated user terminal, and when the designated user terminal pays for the delivery cost, the server is configured to make the drone pick up the package at the pick-up place.

When the drone finishes the delivery of the package to the delivery destination or the intermediate destination, the server is configured to make the drone return to a return place, and when the server receives a request for additionally delivering an additional package at the pick-up place located on a return path, the server is configured to make the drone pick up the additional package and return.

The return place may include a distribution center or a distribution vehicle, and the drone may enable a battery thereof to be charged at the return place.

When a designated user terminal makes a request to change time for delivery of the package, the server is configured to make the drone deliver the package to the intermediate destination, and according to the changed time for delivery of the package, the server may make the drone pick up the package at the intermediate destination and deliver the package to a final destination.

When a designated user terminal makes a request to change a final destination, the server is configured to make the drone deliver the package to the changed final destination or a changed intermediate destination.

According to various exemplary embodiments of the present invention, there is provided a method of delivering a package by use of a drone, the method including: receiving, by a server, a request for delivering the package; picking up, by the drone selected by the server, the package at a pick-up place; delivering, by the drone, the package to a final destination or an intermediate destination; and returning of the drone.

At the picking up of the package at the pick-up place by the drone, the drone may recognize a pick-up point provided in the pick-up place, and when the package positioned at the pick-up place has a size or a weight that the drone is able to carry, the drone is configured to pick up the package.

At the returning of the drone, when a request for additional delivering an additional package is made on a return path of the drone, the drone is configured to pick up the additional package and returns.

According to various exemplary embodiments of the present invention, in the system and the method of delivering the package by use of the drone, the package requested to be delivered is picked up by use of the drone, and in association with an existing package delivery system, the server is configured to make the drone deliver the package to the final destination or the intermediate destination according to a situation, assisting the package delivery system with the drone and increasing the efficiency of the system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a system for delivering a package by use of at least one drone according to various exemplary embodiments of the present invention; and

FIG. 2 is a flowchart illustrating a method of delivering a package by use of a drone according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinbelow, various exemplary embodiments of the present invention will be described in detail with reference to the accompanying drawings. Throughout the drawings, the same reference numerals will refer to the same or like parts.

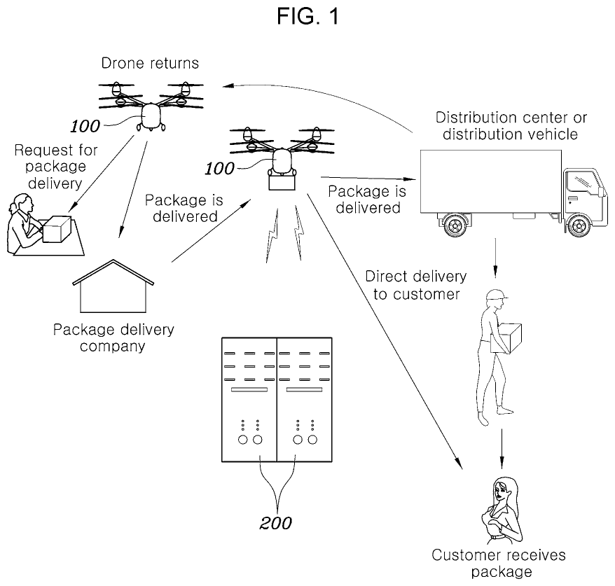

FIG. 1 is a diagram illustrating a system for delivering a package by use of at least one drone according to various exemplary embodiments of the present invention.

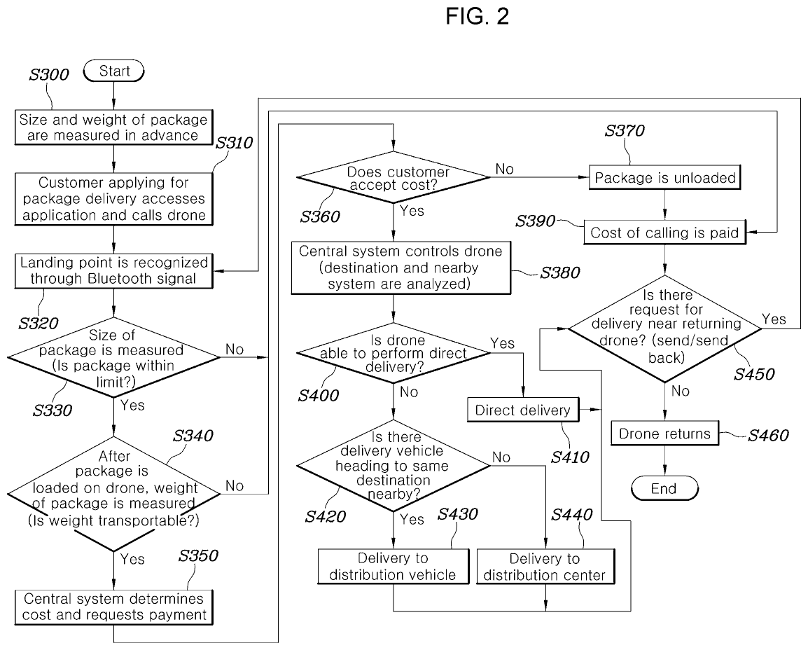

FIG. 2 is a flowchart illustrating a method of delivering a package by use of a drone according to various exemplary embodiments of the present invention.

FIG. 1 is a diagram illustrating a system for delivering a package by use of at least one drone according to various exemplary embodiments of the present invention.

According to the exemplary embodiment of the present invention, a system for delivering a package by use of at least one drone includes: the at least one drone 100 picking up and delivering the package; and a server 200 receiving a request for delivering the package, selecting the drone 100 to be used for delivery of the package among the at least one drone 100, making the drone 100 pick up the package at a pick-up place, making a delivery plan from the pick-up place to a delivery destination, and making the drone 100 deliver the package directly to the delivery destination or deliver the package to an intermediate destination before the delivery destination. Furthermore, when a designated user terminal makes the request for delivery of the package, the server 200 selects the drone 100 positioned nearest to the pick-up place at which the packaged requested by a user to be delivered is positioned among the at least one drone 100, and guides the selected drone 100 to the pick-up place.

A customer may apply for membership of a delivery service application in advance and may use the delivery service application to request delivery that utilizes the drone 100. The customer inputs the size and the weight of the package in advance to the delivery service application. The server 200 determines whether the package is able to be delivered by the drone 100, and informs the customer about a result of determination. Afterwards, when the package is able to be delivered by the drone 100, the server 200 guides the drone 100 to the delivery request place, the drone 100 being positioned nearest to a delivery request place for which the customer requests the package to be delivered among the at least one drone 100.

Furthermore, in the system for delivering the package by use of the at least one drone according to the exemplary embodiment of the present invention, the server 200 makes the delivery plan on the basis of a location of the pick-up place, a location of the delivery destination, or a location of the intermediate destination and guides the drone 100 according to the delivery plan. The intermediate destination may include a distribution center or a distribution vehicle.

For example, the server 200 makes the delivery plan on the basis of a distance from the pick-up place to a final destination. When the drone 100 picks up the package at the pick-up place, the server 200 determines whether the drone 100 is able to move the distance from the pick-up place to the final destination. When the drone 100 is able to move to the final destination, the server 200 sets a path from the pick-up place to the final destination so that the drone 100 is able to deliver the package directly to the final destination, guiding the drone 100. However, when the drone 100 is unable to move the distance from the pick-up place to the final destination, the server 200 finds whether a distribution vehicle heading to the final destination is positioned near the pick-up place, and finds the position of the distribution vehicle. When the distribution vehicle heading to the final destination is positioned nearby, the server 200 makes the drone 100 deliver the package to the distribution vehicle. When there is no distribution vehicle heading to the final destination at a close distance in a predetermined distance, the drone 100 is made to deliver the package to a distribution center located nearest to the pick-up place.

Furthermore, in addition to the distance from the pick-up place to the final destination, the server 200 makes the delivery plan on the basis of delivery urgency of the package or the state of a battery of the drone 100. For example, according to the delivery urgency of the package, as the delivery of the package is urgent, the server 200 makes the drone 100 move as far as possible for direct delivery. Therefore, even in the case of a long distance for the drone 100 to move, the server 200 makes the drone 100 move only as far as the drone is able to and then makes, from the place where the drone has arrived, the drone 100 or the distribution vehicle deliver the package as rapidly as possible. Alternatively, in the case where direct delivery is impossible due to the insufficient power of the battery of the drone 100, the server 200 makes the drone 100 move as far as possible considering the amount of power left in the battery, to deliver the package to the distribution center or the distribution vehicle.

In the meantime, in the system for delivering the package by use of the at least one drone according to the exemplary embodiment of the present invention, the drone 100 is provided with a pick-up sensor to recognize a pick-up point provided in the pick-up place, and when the package is positioned at the pick-up point, the server 200 makes the drone 100 pick up the package. For example, in the system for delivering the package by use of the at least one drone according to the exemplary embodiment of the present invention, the customer of the system may set the pick-up point in the pick-up place in advance. The pick-up point may be on a flat ground so that the drone 100 is able to land thereon. In the case of a general house, a flat ground near the front door is set as the pick-up point in advance. In the case of an apartment, the pick-up point such as a public freight place for drone package delivery is set on the rooftop or the parking place of the apartment in advance.

Furthermore, the pick-up sensor may be a camera, a Bluetooth sensor, or the like. In the case where the pick-up sensor is a Bluetooth sensor, the drone accurately recognizes the pick-up point, which is preset by the customer in the pick-up place, through a Bluetooth signal and lands on the pick-up point at S320 of FIG. 2.

In the meantime, in the system for delivering the package by use of the at least one drone according to the exemplary embodiment of the present invention, the drone 100 is provided with a camera to collect image data of the package, and the server 200 utilizes the image data collected by the camera of the drone 100 to determine whether the package has a size that the drone 100 is able to carry. When the package has the size that the drone 100 is able to carry, the server 200 makes the drone 100 pick up the package at the pick-up place.

Furthermore, in the system for delivering the package by use of the at least one drone according to the exemplary embodiment of the present invention, the drone 100 is provided with a weight sensor to collect weight data of the package, and the server 200 utilizes the weight data collected by the weight sensor of the drone 100 to determine whether the package has a weight that the drone 100 is able to carry. When the package has the weight that the drone 100 is able to carry, the server 200 makes the drone 100 pick up the package at the pick-up place at S330 of FIG. 2.

The drone 100 is a relatively small flight vehicle, and there is a limit in size or weight of a package that the drone is able to carry. Therefore, even after the customer inputs the size or the weight of the package to the delivery service application and even after the server 200 determines whether the package is able to be delivered and guides the drone 100 to the pick-up place, the size or the weight of the package is measured before the drone 100 picks up and delivers the package for safe delivery at S340 of FIG. 2.

The server 200 measures the length, the width, the height, and the like of the package by use of the camera of the drone 100 and determines whether the package has the size that the drone 100 is able to deliver. When the package has the size that the drone 100 is able to deliver, the package is loaded on the drone 100 and a digital scale of the drone 100 is used to determine whether the package has the weight that the drone 100 is able to deliver. That is, the server 200 makes the drone 100 pick up and deliver the package only when the package has the size and the weight that the drone 100 is able to deliver. When the package has a size or a weight that the drone 100 is unable to deliver, the customer is requested to repack the package. When the customer rejects the request, the server 200 makes the drone 100 return and requests the customer to pay for the cost of calling the drone 100. The customer is notified of the cost of calling in advance. For payment for the cost of calling, the customer is requested to apply for membership of the delivery service application and to register payment information.

In the meantime, in the system for delivering the package by use of the at least one drone according to the exemplary embodiment of the present invention, the drone 100 is provided with a camera to collect image data of the package or a weight sensor to collect weight data of the package, and the server 200 utilizes the image data or the weight data collected by the camera or the weight sensor of the drone 100 to determine a delivery cost of the package. Furthermore, the server 200 transmits the determined delivery cost to the designated user terminal, and when the designated user terminal pays for the delivery cost, the server 200 makes the drone 100 pick up the package at the pick-up place. The larger the size of the package or the heavier the weight of the package, the more difficult it is for the drone 100 to deliver the package and the longer delivery time it takes. The delivery cost is increased accordingly. Therefore, the server 200 determines the delivery cost in the picking up of the package by the drone 100 and informs the customer about the delivery cost. Only when the customer accepts the delivery cost, the server 200 makes the drone 100 start delivery at S350 and S360 of FIG. 2. When the customer refuses to pay for the delivery cost, the server 200 request the customer to pay for the cost of calling the drone 100 at S370 and S390 of FIG. 2.

Furthermore, in the system for delivering the package by use of the at least one drone according to the exemplary embodiment of the present invention, when the drone 100 finishes the delivery of the package to the delivery destination or the intermediate destination, the server 200 makes the drone 100 return to a return place. When the server 200 receives a request for additionally delivering an additional package at the pick-up place located on a return path, the server 200 makes the drone 100 pick up the additional package and return. Before the drone 100 finishes the delivery and returns, when the server 200 receives a request for another delivery or a request for returning a package near the drone 100, the server 200 makes the drone 100 visit the place where the request is made, pick up the package, and return, rapidly processing other deliveries at S420, S430, S440, and S450 of FIG. 2.

In the meantime, the return place includes a distribution center or a distribution vehicle, and the drone 100 enables a battery thereof to be charged at the return place. The distribution center or the distribution vehicle is provided with a charging facility, and the drone 100 utilizes the charging facility to charge the battery and prepares for the next delivery.

Furthermore, in the system for delivering the package by use of the at least one drone according to the exemplary embodiment of the present invention, when the designated user terminal makes a request to change time for delivery of the package, the server 200 makes the drone 100 deliver the package to the intermediate destination. According to the changed time for delivery of the package, the server 200 makes the drone 100 pick up the package at the intermediate destination and deliver the package to the final destination. For example, in the case of fresh food, such as refrigerated food, and the like, which may be received by the customer on the same day, the customer needs to receive the food at the correct time and refrigerate the food again. If the customer is unable to receive the food due to urgent circumstances, there is a problem that the fresh food goes bad, and the like. Therefore, the server 200 notifies the customer of the estimated time for arrival. When the customer is unable to receive the package at the estimated time for arrival, the customer may make a request to change the time for delivery through the delivery service application. The server 200 makes the drone 100 deliver the package to a nearby warehouse, or the like, to store the package in the warehouse, and makes the drone 100 deliver the package to the delivery destination at a time when the customer wants.

In the meantime, in the system for delivering the package by use of the at least one drone according to the exemplary embodiment of the present invention, when the designated user terminal makes a request to change the final destination, the server 200 makes the drone 100 deliver the package to the changed final destination or a changed intermediate destination. When the customer changes the final destination of the package through the delivery service application, according to the current position of the package, the server 200 makes the drone 100 deliver the package directly to the changed final destination or deliver the package to the warehouse or the distribution vehicle nearest to the current position of the package.

FIG. 2 is a flowchart illustrating a method of delivering a package by use of a drone according to various exemplary embodiments of the present invention. A method of delivering a package by use of a drone according to the exemplary embodiment of the present invention includes: receiving, by a server, a request for delivering the package at step S310; picking up, by the drone selected by the server, the package at a pick-up place at step S380; delivering, by the drone, the package to a final destination or an intermediate destination at steps S400, S410, S430, and S440; and returning of the drone at step S460.

Furthermore, in the method of delivering the package by use of the drone according to the exemplary embodiment of the present invention, in the picking up of the package at the pick-up place by the drone at step S380, the drone is configured to recognize a pick-up point provided in the pick-up place, and when the package positioned at the pick-up place has a size or a weight that the drone is able to carry, which is measured at step S300, the drone is configured to pick up the package.

In the meantime, in the method of delivering the package by use of the drone according to the exemplary embodiment of the present invention, at the returning of the drone at step S460, when the server receives a request for additionally delivering an additional package on a return path of the drone, the drone is configured to pick up the additional package and returns.

That is, the system and the method of delivering the package by use of the drone according to the exemplary embodiments of the present invention increase the efficiency of the existing package delivery system by assisting the existing system through the drone 100, and deliver a package accurately and rapidly to a customer.

In an exemplary embodiment of the present invention, the drone may include a controller to perform an operation thereof according to command signal received from the server.

In addition, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

In an exemplary embodiment of the present invention, each operation described above may be performed by a controller, and the controller may be configured by multiple controllers, or an integrated single controller.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for delivering a package by use of at least one drone, the system comprising:
the at least one drone configured for picking up and delivering the package; and
a server configured for receiving a request for delivering the package, selecting a drone to be used for delivery of the package among the at least one drone, making the selected drone pick up the package at a pick-up place, making a delivery plan from the pick-up place to a delivery destination, and making the selected drone deliver the package directly to the delivery destination or deliver the package to an intermediate destination located before the delivery destination.

2. The system of claim 1, wherein upon determining that a designated user terminal makes the request for delivery of the package, the server is configured to select a drone positioned nearest to the pick-up place at which the package requested by a user to be delivered is positioned among the at least one drone, and guides the selected drone positioned nearest to the pick-up place, to the pick-up place.

3. The system of claim 1,
wherein the server is configured to make the delivery plan according to a location of the pick-up place, a location of the delivery destination, or a location of the intermediate destination and guides the selected drone according to the delivery plan, and
wherein the intermediate destination includes a distribution center or a distribution vehicle.

4. The system of claim 1, wherein the drone is provided with a pick-up sensor to recognize a pick-up point provided in the pick-up place, and upon determining that the package is positioned at the pick-up point, the server is configured to make the drone pick up the package.

5. The system of claim 1, wherein the selected drone is provided with a camera to collect image data of the package, and the server is configured to utilize the image data collected by the camera of the selected drone to determine whether the package has a size that the selected drone is able to carry, and upon determining that the package has the size that the selected drone is able to carry, the server is configured to make the selected drone pick up the package at the pick-up place.

6. The system of claim 5, wherein the selected drone is provided with a weight sensor to collect weight data of the package, and the server is configured to utilize the weight data collected by the weight sensor of the selected drone to determine whether the package has a weight that the selected drone is able to carry, and upon determining that the package has the weight that the selected drone is able to carry, the server is configured to make the selected drone pick up the package at the pick-up place.

7. The system of claim 6, wherein after the server concludes that the package is able to be delivered by the selected drone and guides the selected drone to the pick-up place, the size or the weight of the package is measured again before the drone picks up the package, by the server.

8. The system of claim 1, wherein the selected drone is provided with a camera to collect image data of the package or a weight sensor to collect weight data of the package, and the server is configured to utilize the image data or the weight data to determine a delivery cost of the package.

9. The system of claim 8, wherein the server is configured to transmit the determined delivery cost to a designated user terminal, and upon determining that the designated user terminal pays for the delivery cost, the server is configured to make the selected drone pick up the package at the pick-up place.

10. The system of claim 1, wherein upon determining that the selected drone finishes the delivery of the package to the delivery destination or the intermediate destination, the server is configured to make the selected drone return to a return place.

11. The system of claim 10, wherein upon determining that the server receives a request for additionally delivering an additional package at the pick-up place located on a return path, the server is configured to make the selected drone pick up the additional package and return.

12. The system of claim 10, wherein the return place includes a distribution center or a distribution vehicle, and the selected drone is configured to selectively charge a battery of the selected drone at the return place.

13. The system of claim 1, wherein upon determining that a designated user terminal makes a request to change time for delivery of the package, the server is configured to make the selected drone deliver the package to the intermediate destination, and according to the changed time for delivery of the package, the server is configured to make the selected drone pick up the package at the intermediate destination and deliver the package to a final destination.

14. The system of claim 1, wherein upon determining that a designated user terminal makes a request to change a final destination, the server is configured to make the selected drone deliver the package to the changed final destination or a changed intermediate destination.

15. A method of delivering a package by using a drone, the method including:
receiving, by a server, a request for delivering the package;
picking up, by the drone selected by the server, the package at a pick-up place;
delivering, by the drone, the package to a final destination or an intermediate destination; and
returning of the selected drone.

16. The method of claim 15, wherein in the picking up of the package at the pick-up place by the selected drone, the selected drone is configured to recognize a pick-up point provided in the pick-up place, and upon determining that the package positioned at the pick-up place has a size or a weight that the selected drone is able to carry, the selected drone is configured to pick up the package.

17. The method of claim 15, wherein at the returning of the selected drone, upon determining that a request for additionally delivering an additional package on a return path of the selected drone is received, the selected drone is configured to pick up the additional package and returns.

18. The method of claim 16, wherein after the server concludes that the package is able to be delivered by the selected drone and guides the selected drone to the pick-up place, the size or the weight of the package is measured again by the server before the selected drone picks up the package.
